(19) United States
(12) Patent Application Publication
(10) Pub. No.: US 2010/0001236 A1
(43) Pub. Date: Jan. 7, 2010

(54) Method of producing trichlorosilane (TCS) rich product stably from a fluidized gas phase reactor (FBR) and the structure of the reactor

(76) Inventors: YongChae Chee, Beverly Hillss, CA (US); Tetsunori Kunimune, La Canada, CA (US)

Correspondence Address: Yong Chae CHEE, 3099 N. Lima St., Burbank, CA, 91504, US

(21) Appl. No.: 12/456,979

(22) Filed: Jun. 25, 2009

Related U.S. Application Data
(60) Provisional application No. 61/133,688, filed on Jul. 1, 2008.

(51) Int. Cl. C09K 3/00

(52) U.S. Cl. 252/372

(57) ABSTRACT

A fluidized bed reactor (FBR) for producing tri-chlorosilane (TCS) from metallurgical silicon (MGSI) and method of producing TCS stably with the FBR is disclosed. The FBR according to current application is comprised of 1) a straight lower bed section whose height over inner diameter ratio (H/D) is in the range of 3 to 6, 2) an expanded zone that has steep angle lower than 7 degree from the vertical line of the lower bed section, 3) a hemi-sphere top section on a flange for internal cooler, 4) a straight upper section of the reactor, 5) an internal cooler with flange, 6) a gas distribution plate, 7) a feed inlet line that has angle lower than 20 degree from the vertical line of the lower bed section, 8) a cyclone installed upper-outside of the FBR, 9) a recycle line from an outside cyclone that has angle lower than 20 degree from the vertical line of the lower bed section, 10) a seed bed hopper located vertically at the top of the hemi-sphere top section, 11) an outer cooling jacket surrounding the outside of the lower bed section, and 12) a feeder that controls feed rate of MGSI within ±5% accuracy.

This is the Non-provisional application of the Provisional Application No. 61/133,688 which was filed on Jul. 1, 2008.

### FIELD OF THE INVENTION

Current application relates to a FBR, especially to a FBR structure for producing TCS from Si and HCl and the method of stably producing TCS.

### BACKGROUND OF THE INVENTION

Since the steep increase of the crude oil price, solar energy technology has been paid attention for the advantage of scale up to large power plant as far as the Sun lights. However, the raw material for solar-cell is in short because of limited number of plants that produce the raw material, polysilicon. In later 1970's, Union Carbide researched possibility of producing “low cost silicon solar array” under contract with NASA. They used fluidized bed to produce mixed silane of STC (Silicon Tetra Chloride), TCS (Tri-Chloro-Silane), DSC (Di-Chloro-Silane), and Silane (SiH₄) from Metallurgical Silicon (Fine particular silicon of particle size about 200 micrometer). However, their disclosures are primitive study to kinetics of Hydrogenation of Silicon at abut 350° C., 300 Psig. No continuous operation is disclosed. Other U.S. patents up to now failed to disclose stable continuous operation method of a fluidized bed reactor to produce mixture of Silane gases from metallurgical silicon. It is purpose of the current application to provide a technology that enables stable continuous production of mixed silane gas using metallurgical grade silica in a fluidized bed reactor.

### Description of the Prior Art

U.S. Pat. No. 2,943,918 to G. Pauls illustrates a process for manufacturing dense, extra pure silicon. That process contains a chlorosilane producing unit, major product is trichlorosilane (TCS), from metallurgical grade silicon. The TCS manufacturing unit is made of a steel pipe 1. The pipe 1 has a grid 2 that support the charge of silicon-copper alloy (these material is call as metallurgical silicon). Dry HCl is introduced from the bottom of the pipe 1 and pass through the silicon-copper alloy bed and leave the pipe at the top exit 7. The system was heated up to 240° C. and maintained using proper means. It produced TCS rich chlorosilane product. The silicon-copper alloy was charged once and no make up was done. It might be in fluidized bed mode but not in continuous steady state. They described in lines 60 to 67 of column 1 that the reaction between the silicon and HCl is very exothermic and they had to decrease the HCl flow rate to maintain the reaction temperature at desired range and so it limits the production rate of TCS.

U.S. Pat. No. 3,148,035 to Enk, et al. illustrates an apparatus for the continuous production of silicon chloroform (trichlorosilane; TCS) and/or silicon tetra-chloride (STC). The apparatus is characterized by a conical insert in the fluidized bed just above the distribution plate. The conical insert act two functions. First is to provide a cooling surface and the second is to provide a channel to discharge un-reacted solid particles. They claim that continuous removal of the un-reacted particles enabled a continuous operation. But, no information for feeding method and no information how to distinguish the fresh particle and un-reacted particle to remove from the reactor. It clearly indicates low efficiency of silicon particle use. Or the discharged material through the over outlet 12 should be recycled to the feeding conduit 8.

U.S. Pat. No. 3,704,104 to Bawa, et al. illustrates a process for the production of trichlorosilane. They claim that recycling ethylenedichloride (EDC) to their FBR increased the yield of TCS. But, their FBR structure was not disclosed.

U.S. Pat. No. 4,213,937 to Padovani, et al. illustrates a commercial scale plant design for producing granular polysilicon from TCS/STC mixture that is produced in a FBR from reacting silicon with HCl. They disclose the FBR design, which have expanded upper head section and inner cooler that reaches down to the fluidizing bed. They operated the FBR at 500 to 750° F. and 8 to 10 psig. Solid impurities are removed by solid dump line at the bottom of the reactor. However, they did not disclose the feeder in detail. Moreover, they did not disclose what the bed level inside of the FBR is. Especially, when the internal cooling coil is inserted to the moving bed, it creates many problems, such as slugging and erosion of the cooling coil itself by the silicon granules.

U.S. Pat. No. 4,585,643 to Barker, Jr illustrates a Process for preparing chloro-silanes from silicon and hydrogen chloride using an oxygen promoter. The inventor used a laboratory scale glass fluidized bed reactor (FBR). The ratio of bed height/diameter of the FBR was maintained as 10˜11/1. Silicon was made up to maintain the bed level. Though this result is limited to a laboratory scale FBR, the bed level itself causes slugging, which is very bed for heat transfer from the bed to the reactor wall. Many times slugging confuses the operator to find out what is the real steady state.

U.S. Pat. No. 5,776,416 to Oda illustrates a FBR for producing TCS rich products from hydrogenation of silicon-tetrachloride (STC). The FBR is equipped with internal cyclone and has expanded free board upper zone. Oda illustrates dimension of the bench scale reactor. However, he made mistake that the internal cyclone is proven as not only non-functional but creates many additional problems by the FBR industry. Moreover, he misunderstood the function of the expanded zone.

Based on the decades FBR operational experience of the applicant of the current application, that reactor will not perform smoothly. The internal cyclone itself disturbs continuous operation of the FBR at that high temperature.

In addition to Oda's disclosure, all the prior arts do not disclose optimized FBR structure and operational method for producing TCS from silicon and HCl stably.

It is the purpose of the current application to provide an industrially practical FBR to produce TCS stably in terms of commercial operation.

It is another purpose of the current application to provide a method of producing TCS stably with the FBR disclosed.

Many preliminary works have been done to find the optimized structure of the FBR and the method of operation of the FBR.

### DESCRIPTION OF THE DRAWINGS

FIG. 1 is a perspective view of a cold fluidized bed to optimize the ‘Operating Bed Height’ of the solid materials.

FIG. 2 is an elevated view of a gas distributor used in the cold fluidized bed according to current application.

FIG. 3 is a side cross sectional view of the fluidized bed reactor for stable production of trichlorosilane by hydrochlorination of metallurgical silicon according to current application.

FIG. 4 is a prior art that shows the cross-sectional view of “A” part in the FIG. 3.

FIG. 5 is a cross sectional view of the new gas distributor designed according to current invention.

### DETAILED DESCRIPTION OF THE PREFERRED EMBODIMENT OF THE INVENTION

As known to public, Fluidized Bed Reactor (FBR) is selected for extremely exothermic reaction due to their excellent mixing and heat removal capacity from the internal ‘bed’ of fluidized materials.

Among the various stage of the FBR, ‘slugging bed’ is known as ‘must be avoided’ because of their unstable bed behavior and many ‘entrainment of bed material’ to the exit gas stream (Fluidization Engineering, John Wiley & Sons, Inc., pp 1˜3, Daizo Kuni and Octave Levenspiel). When the phenolmenon ‘slugging’ happens, upper part of the gas-solid bed is pushed upward, separated from the main bed. Therefore, when the ‘bed’ is operated as ‘slugging mode’, the heat transfer within the bed and between the bed and reactor wall surface decreases because the heat transfer coefficient of gas is normally lower than that of the solid material. This phenomenon is typical in a gas -solid FBR.

Meanwhile, the reaction between HCl and silicon to produce TCS is known as extremely exothermic witnessed by many of the prior arts. And most of the prior arts tried to control this exothermic heat.

Therefore, it is naturally concluded that maintaining the ‘bed’ of the reactant in a ‘bubbling bed’ state is the first thing to be resolved because none of the prior arts disclosed what is the parameter that categories the boundary of ‘bubbling bed.’

Determining “Bubbling Bed” Condition.

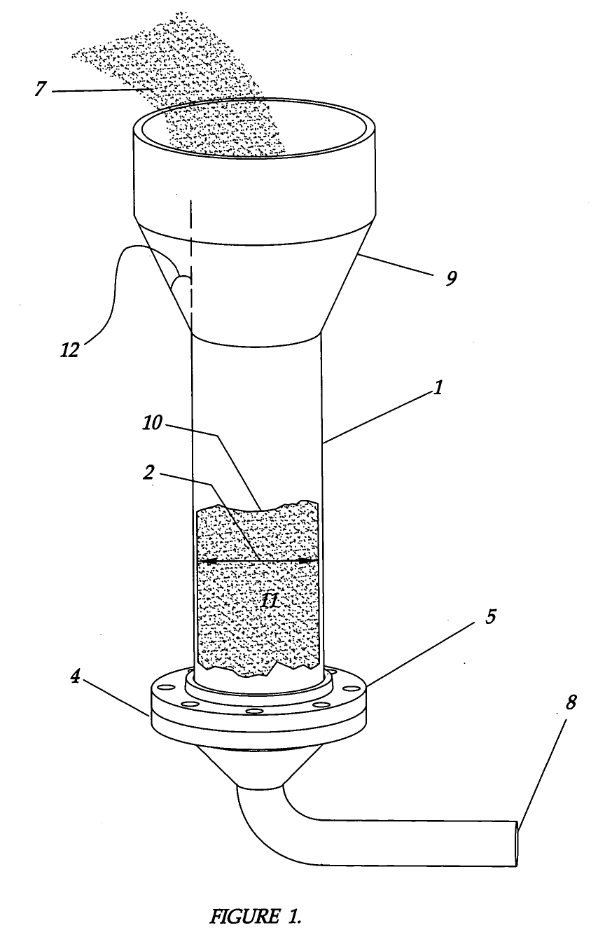

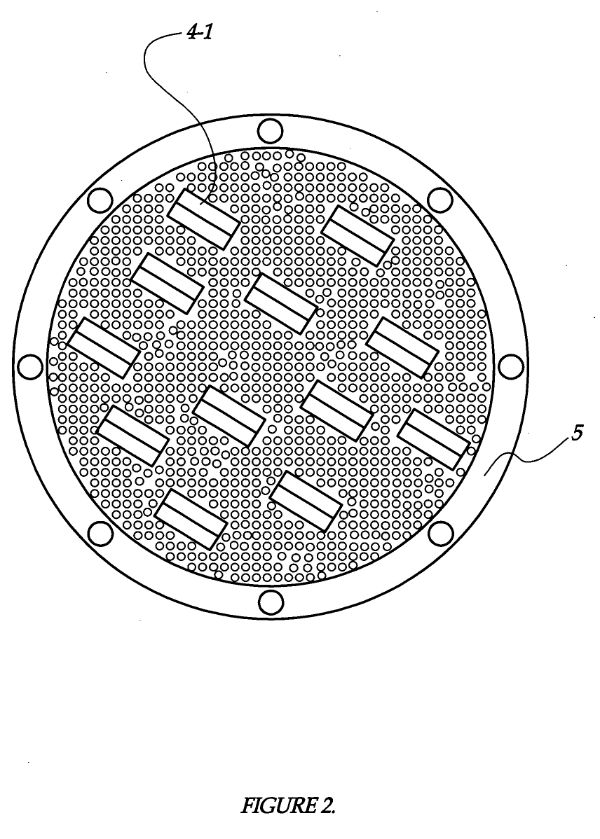

The applicant started from this point with a transparent cold bed of a FBR as shown in the FIG. 1. The lower portion (1) of the cold bed FBR is made of three pieces of transparent acrylate pipes of inner-diameter (2), d₁, of 15 cm. Wall thickness (3) of the lower portion is 1 cm to hold the bed weight. Bottom of the lower portion (1) is supported by a gas distributor (4) and fastened via a flange (5) as shown in the FIG. 2. The gas distributor (4) is made of a perforated stainless 304 plate of 1 cm thick. Pluralities of 1 mm diameter holes (6) are evenly developed across the whole gas distributor (4) and pluralities of chevron type gas hole caps (4-1) covers the holes (6). Inside of the lower portion (1) of the cold bed FBR is filled with dry sands (7) within particle diameter range of 150 to 200 micrometer. The sands were dried in an oven which is maintained at 400° C. for over night under nitrogen atmosphere (evaporated liquid nitrogen; 99.999%) to drive out the moisture soaked therein. The dried sands (7) were cooled to room temperature under the same nitrogen atmosphere. The cold bed FBR was purged with the same nitrogen over night. The cooled sands (7) are charged to the lower portion (1) of the cold bed FBR from the above while the FBR is slightly purging with the nitrogen. Bulk density of the dried sand (7) was 0.98 to 1.02. Height of the sand (7) bed was varied as shown in the table 1. Nitrogen (8) vaporized from a 200 liter liquid nitrogen container was compressed and used as the fluidizing medium. Specific gas velocity of the nitrogen in the lower portion (1) of the FBR was varied from 10 cm/sec to 30 cm/sec.

TABLE 1

| H/d₁* | SGV** | |
|---|---|---|
| (initial) | (Cm/sec) | Slugging*** |
| 1 | 10 | No |
| | 20 | No |
| | 30 | No |
| 2 | 10 | No |
| | 20 | No |
| | 30 | No |
| 3 | 10 | Yes, Slight |
| | 20 | Yes, moderate |
| | 30 | Yes, |
| 4 | 10 | Yes |
| | 20 | Yes, bed unstable |
| | 30 | Yes, particles blow out |
| 5 | 10 | Yes, particles blow out |
| | 20 | Yes, particles blow out |
| | 30 | Yes, particles blow out |
| 6 | 10 | Yes, becomes entrained |
| | 20 | Yes, entrained |
| | 30 | Yes, severe entrain |

*H is the height of the sand bed charged initially, d₁ is the inner diameter of the Lower portion of the FBR.
**SGV is the specific gas velocity of nitrogen in the bed.
***Slugging is a phenomenon that the fluidizing bed is separated in two zones.

The applicant found from his long experience of FBR operation that relative value of the ‘height of the fluidized bed of the solid particles’ and ‘internal diameter of the fluidizing vessel’ is the key parameter that categorize the boundary of ‘bubbling bed’ and ‘slugging bed.’ However, the ‘height of the fluidized bed of the solid particle’ varies depends on the SGV. So, ‘initial bed height of the charged solid particles’ is selected as one parameter.

As shown in the table 1, the ‘slugging’ does not occur within the SGV range lower than 30 cm/sec until the ‘initial bed height of the charged solid particles’ (H)/‘inner diameter of the fluidizing vessel’ (d₁) reaches over 2. At the level of H/d₁=2, the ‘height of the fluidized bed of the solid particles’ reaches five times of the vessel's inner diameter, d₁, when SGV is 30 cm/sec. When H/d₁ is higher than 3, slugging starts even at SGV of 10 cm/sec. At this moment, the ‘height of the fluidized bed of the solid particles reached around six times of the inner diameter of the fluidizing vessel. Upper section of the ‘fluidized bed of the solid particles’ is separated from the rest of the bed and is raised higher followed by collapse of the separated portion. As the H/d₁ is higher than 4, ‘slugging’ accompanied with ‘entrainment’. So, the solid particles come out of the FBR.

The other founding is that, when the slope of the expending section (9) is low, particles that leave the top surface (10) of the fluidized bed (11) accumulate on the inner surface of the expanding section (9). By trial and error, it was found that the angle (11) of the slope of the expanding section (9) from a vertical line should be smaller than 7 degree.

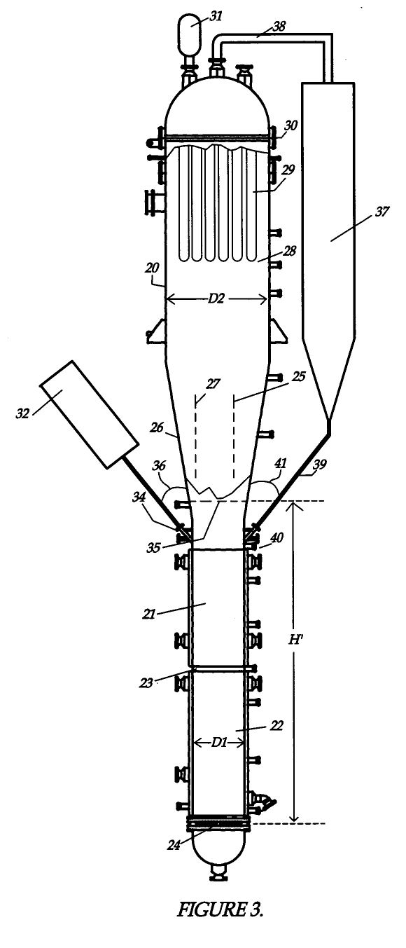

Based on the above findings, the FBR (fluidized bed reactor) (20) for TCS production according to current application is designed as shown in the FIG. 3.

The key points of the feature of the FBR (20) according to current application are as follows;
In the lower reactor section (21) of the FBR (20), the ratio of the height of the straight zone (H′) over internal diameter (D₁) is fixed between three to six.
Cooling jacket (22) surrounds the outer surface (23) of the lower reactor section (21).
A gas distribution plate (24), which has pluralities of small holes and hole caps as shown in the FIG. 3, is installed at the bottom of the lower reactor section (21).
Expanding zone (25) maintains an angle (26) from a vertical line (27), which is extended from the wall of the lower reactor section, smaller than 7 degree and expands until the inner diameter (D₂) of the upper reactor section (28) reaches over two times of the inner diameter (D₁) of the lower reactor section (21).
An internal cooler (29) is installed inside of the upper reactor section (28) via a flange (30) for easy replacement of eroded cooler (29).
A seed bed hopper (31) is installed at the top of the upper reactor section to dump in the seed bed material at the start up of the FBR (20).
A powder feeder (32) is connected to the FBR (20) via a feeding line (33) that reaches a point (34) just below the upper end (35) of the lower reactor section (21) with an angle (36) from a vertical line, which is extended from the wall of the lower reactor section, smaller than 20 degrees.
A cyclone (37) is connected to the FBR (20) via an exit gas line (38) from the top of the FBR (20) and via a recycling line (39) that reaches a point (40) just below the upper end (35) of the lower reactor section (21) with an angle (41) from a vertical line smaller than 20 degrees.
The powder feeder (32) controls feeding rate of the silicon at a range of 1 Kg/hr to 100 Kg/hr with ±5% deviation at a pressure of 150 Pisa.

For producing TCS rich silane mixture by the hydrogenation/hydro-chlorination of metallurgical silicon, the FBR (20) is operated as follows; The FBR (20) is purged with vaporized liquid nitrogen properly before start up. The reactor is filled with proper inert seed bed (42) materials, including but not limited with, non-porous silica or porous silica, such as Grace Davison 952, quartz powder, sand or equivalent. Those materials should have elemental Si contents at least 99.8 wt %. Particle size, true density, and bulk density of the seed bed material is equivalent to that of the metallurgical silicon as shown in the Table 2.

TABLE 2
Properties

| | |
|---|---|
| Particle size | 100~150 |
| Bulk Density (g/cc) | 0.98~1.02 |
| True Density (g/cc) | 1.98~2.01 |
| SiO₂ content (wt %) | >99.8 |

Amount of seed bed (42) introduced at the start up is the amount that can fill the height (H) of the lower reactor section (21) with the dimension that is equivalent to one to three times of the internal diameter (D₁) of the lower reactor section.

The FBR (20) system is purged and fluidized with vaporized liquid nitrogen introduced to the seed bed (42) from the bottom through the gas distribution plate (24) at 100° C. in a bubbling bed mode until the effluent gas contains moisture less than 0.1 ppm.

Then, the seed bed (42) temperature is increased up to 400° C. Then nitrogen is switched to hydrogen chloride or hydrogen with silicon chloride. At the same time metallurgical grade silicon particles (43) are introduced to the silica seed bed (42) through a silicon feeding line (33), which reaches a point (34) just below the upper end (35) of the lower reactor section (21) with an angle (36) from a vertical line, which is extended from the wall of the lower reactor section, smaller than 20 degrees.

The silicon feeding line (33) is connected to an outer carrier gas feeding line (44). Hydrogen chloride at room temperature is introduced through the carrier gas feeding line (44) and disperses and carries the silicon particles (43) into the bed to produce TCS. For the TCS (Trichlorosilane) production, the cold hydrogen chloride gas removes heat generated by the reaction of silicon with hydrogen chloride. It will reduces burden of the internal cooler (29) that used to be placed over the seed bed (42). Major portion of HCl is heated up to 100° C. and introduced to the FBR from the bottom of the FBR through the gas distribution plate (24).

As disclosed in many prior arts, they start up the TCS production by directly contacting hydrogen chloride with silicon bed piled in the reactor. Then, the reaction between the two reactants faces non-stoichiometric situation. Therefore, the yield of TCS or desired silicon chlorides must be lower than that from the stoichiometric reaction conditions.

In addition to that, every prior art mentioned about severe exothermic at the beginning of the TCS synthesis reaction. So, un-necessarily excess amount of the silicon in a commercial reactor at the start-up will cause severe temperature shooting. It is not only easy to control the initial exotherm but also dangerous for safe operation. Especially when the reactor is big, the initial temperature shooting may result disaster. That is why most of FBR for TCS operating in China these days is small.

To avoid such dangerous initial exotherm, the applicant developed two methods.

First method is to use seed bed material to disperse the exothermal heat of reaction uniformly throughout the entire reaction bed, not reactor. The seed bed material is chemically inert at the reaction environment and the physical properties are same as those of the silicon granule used as reactant. Pure silica (SiO₂) granules have the same physical properties and showed no chemical reaction at the reaction conditions of 350° C. and at 5 atm pressure. Second method is to use a feeder that feeds silicon granules continuously with accuracy of ±5% at 105 Pisa. It is well known in this industry that on-off valve or some ball valves are used in commercial TCS/STC synthesis process. On-off valves provide pulse feeding and ball valves are easily worn out by the silicon granules. So, both valves provide unstable feeding. In any case, when the heat of the reaction is not severe, it may be commercially acceptable. But, in case of TCS synthesis the heat of reaction is known as severe. Therefore, pulse or unstable feeding of the silicon granules result in ramping of the reactor temperature and loose of temperature control. It is clear that the reaction condition becomes unstable and the products composition distribution also unstable according to the unstable temperature control.

By combining the above methods, the applicant can introduce the metallurgical silicon and HCl in to the reactor at a mole ratio of 1 to 3 to realize a stoichiometrical reaction condition in a FBR's reaction bed.

Since the seed bed (42) is inert to the reaction, this technique can avoid large amount of heat generated at the initial state of the reaction when the bed is filled with one of the reactant, silicon.

The role of the silica, SiO₂, is not limited to the dilution of the heat generated. The metallurgical silicon available from the market has large amount of fine particles of micron order. Those submicron particles usually blown up ward and stick to the cold surface of the inter cooler to reduce the heat transfer coefficient of the cooler. In addition to this, those fine particles are carried over to the next process and cause lot of erosion problems. If use porous silica, the porous silica bed encaptures such fine particles inside of the structural pore and makes them react to produce gaseous products to the last moment.

The end of the silicon feeding line (33), which is embedded just under the upper surface of the seed bed (42) with an angle from a vertical line, which is extended from the wall of the lower reactor section, smaller than 20 degrees, reduces the chance of that fine particle silicon blown up to the internal cooler (29). Meanwhile, in most of the prior art, the silicon powder is introduced from the top of the reactor for silicon hydrogen-ation or hydro chlorination. Then the particles should pass through the region around the internal cooler (29) and stick to the surface of the internal cooler (29). The combination of the silica seed bed (42) and injection of the silicon on the upper surface of the silica seed bed (42) reduces chance of local hot spot forming.

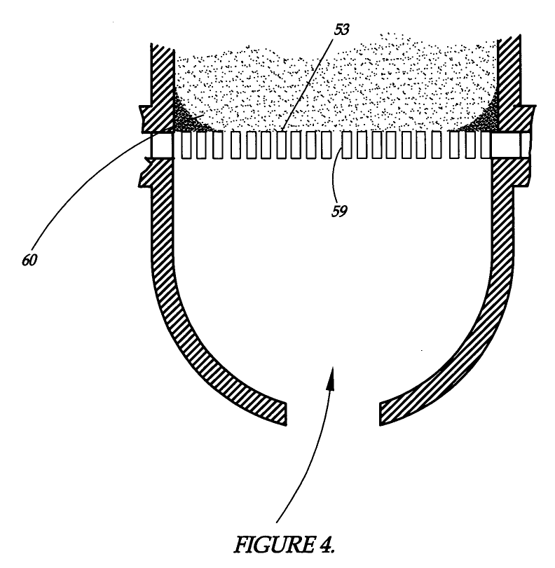

FIG. 4 is a prior art that shows the cross-sectional view of “A” part in the FIG. 3. Usually the gas distributor (53) is a flat panel with pluralities of gas holes (59). Therefore, a stationary zone (60) is developed at the corner of the distributor (53) and the bottom of the bed. The bed does not move at this stationary zone (60). Then, heat generated by the reaction can not be removed by the gas and a hot spot is formed. At this hot spot the reaction produces non-desirable result, such as high molecular weight siloxane, molten particles aggregated together. Then the bubbling fluidized bed is collapsed and the efficiency of the bed is decreased.

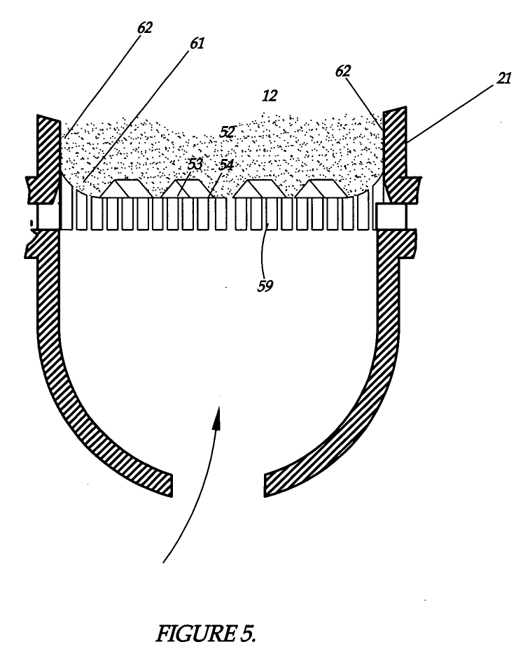

FIG. 5 is a cross sectional view of the new gas distributor (53′) designed according to current invention. The new gas distributor has a brim that is rounded concavely to form a smooth rounded inner surface (61) between the vertical inner surface (62) of the lower reactor section (21) and the gas distributor (53′). Pluralities of chevron shape gas hole caps (54) are developed on the flat upper surface of the new gas distributor (53′). Due to the smoothly rounded inner corner surface, the bed (52) circulates naturally along the gas stream. This new gas distributor (53′) will reduce the chance of developing a stationary zone at the bottom of the bed.

With combination of the features, the fluidized bed will produce TCS rich silane mixture gas more stably and continuously.

What is claimed is:

1. A method of producing TCS rich silane gas mixture stably in a fluidized bed reactor, which is comprised of;
a lower reactor section of the fluidized bed, in which the ratio of the height of the straight zone (H′) over internal diameter (D₁) is fixed as three,
and
a cooling jacket surrounding the outer surface of the lower reactor section,
and
a gas distribution plate, whose brim is rounded concavely to form a smooth round inner surface between the vertical inner surface of the lower reactor section
and
which is installed at the bottom of the lower reactor section
and
which is equipped with pluralities of gas holes and pluralities of chevron shape gas hole caps on the upper flat surface,
and
an upper reactor section,
and
an expanding zone locates between the lower reactor section and the upper reactor section
and
maintains an angle from a vertical line smaller than 7 degree and expands until the inner diameter (D₂) of the upper reactor section reaches over two times of the inner diameter (D₁) of the lower reactor section,
and
an internal cooler that is installed inside of the upper reactor section via a flange for easy replacement of eroded cooler,
and
a seed bed hopper that is installed at the top of the upper reactor section to dump in the seed bed material at the start up of the fluidized bed reactor,
and
a powder feeder that controls feeding rate of the silicon at a range of 100 Kg/hr with ±5% deviation at a pressure of 150 Pisa and is connected to the fluidized bed reactor via a feeding line that reaches a point just below the upper end of the lower reactor section with an angle from a vertical line smaller than 20 degrees,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees.

2. A method of producing TCS rich silane gas mixture stably with a fluidized bed reactor of the claim 1, wherein the amount of seed bed introduced at the start up is the amount that can fill the height (H) of the lower reactor section with a dimension that is equivalent to the internal diameter (D₁) of the lower reactor section.

3. A method of producing TCS rich silane gas mixture stably with a fluidized bed reactor of the claim 1, wherein the amount of seed bed introduced at the start up is the amount that can fill the height (H) of the lower reactor section with a dimension that is two times of the internal diameter (D₁) of the lower reactor section.

4. A method of producing TCS rich silane gas mixture stably with a fluidized bed reactor of the claim 1, wherein the amount of seed bed introduced at the start up is the amount that can fill the height (H) of the lower reactor section with a dimension that is three times the internal diameter (D₁) of the lower reactor section.

5. A method of producing TCS rich silane gas mixture stably with a fluidized bed reactor of the claim 1, wherein the mole ratio of HCl and metallurgical silicon introduced to the reactor is controlled as 3 to 1.

6. A method of producing TCS rich silane gas mixture stably with a fluidized bed reactor of the claim 1, wherein part of HCl is introduced to the fluidized bed reactor at room temperature through the carrier gas feeding line.

7. A method of producing TCS rich silane gas mixture stably with a fluidized bed reactor of the claim 1, wherein the end of the silicon feeding line is embedded just under the upper surface of the seed bed with an angle from a vertical line, which is extended from the wall of the lower reactor section, of 20 degree.
